(19) United States
(12) Patent Application Publication
(10) Pub. No.: US 2020/0311806 A1
(43) Pub. Date: Oct. 1, 2020

(54) AUCTION DATA PROCESSING APPARATUS AND METHOD

(71) Applicant: BETSOLD LIMITED, Glasgow (GB)

(72) Inventors: Colm CAMPBELL, Glasgow (GB); Nicola YOUNG, Glasgow (GB)

(73) Assignee: BETSOLD LIMITED, Glasgow (GB)

(21) Appl. No.: 16/845,210

(22) Filed: Apr. 10, 2020

Related U.S. Application Data
(63) Continuation-in-part of application No. PCT/EP2018/069042, filed on Jul. 12, 2018.

(30) Foreign Application Priority Data
Oct. 11, 2017 (GB) 1716653.9

(51) Int. Cl. G06Q 30/08; G06Q 30/06; G06Q 50/34; G06F 16/23; G06F 9/54; G06F 9/451

(52) U.S. Cl. CPC G06Q 30/08; G06Q 30/0641; G06F 9/451; G06F 16/2379; G06F 9/542; G06Q 50/34

(57) ABSTRACT

Apparatus and a method for processing auction data using a mass data store storing structured auction data defining the status of an auction and a temporary data store is disclosed. A processor executes stored processor implementable instructions to cause the processor to receive bid data representing bids for an auction lot the subject of the auction; process and store the bid data in the mass data store to record the current confirmed status of the auction; receive event data representing an event during the auction that potentially closes the auction; after receiving the event data, cease processing and storing the bid data in the mass data store and store the bid data for any bids received after the event data in the temporary data store; receive event determination data indicating whether the event is confirmed or not; if the event determination data indicates that the event is not confirmed, process the bid data stored in the temporary data store, store the processed bid data in the mass data store to record and update the current confirmed status of the auction, and resume receiving, processing and storing the bids in the mass data store to record the current confirmed status of the auction; and if the event determination data indicates that the event is confirmed, update the status of the auction to closed.

### FIELD OF THE INVENTION

The present invention relates to apparatus and a method for processing auction data.

### BACKGROUND INFORMATION

Online auctions for auction lots performed over the Internet have become commonplace, with eBay® being one of the most notable. Systems operating auction processes encounter a number of technical problems in the provision of the online auction service.

One such technical problem is how to manage signal transmission delays over the Internet and how to synchronize auction timings in network connected systems.

Online auctions can be used for any commodity, item or instrument, including products and services. A bet or wager can be considered as a commodity or instrument having a potential value dependent upon the outcome or occurrence of an event.

The auctioning of bets made on the outcome or occurrence of an event, such as a sporting event, entertainment event, political event, and even the weather has been disclosed in international patent application PCT/GB2017/050620, by the present applicants, the content of which is hereby incorporated by reference.

Bets are placed based on odds offered for an expected outcome or occurrence of the event and a monetary value in the form of a stake is placed. A person placing a bet will be given an electronic record when the bet is placed electronically e.g. over the Internet. The entities offering to accept such bets are usually termed bookmakers. The bookmakers set the odds that they are prepared to offer for an event occurring. If the event outcome is as bet upon, the bookmaker will pay the person placing the bet (the bet owner) the winnings calculated based on the stake and the odds.

A bet thus has a potential monetary value and will have a termination point, which is the point in time at which an event outcome occurs, either as bet or not. Some bets can be simple, such as 10/1 it will snow on Christmas day, or complex based on a compound event such as 20/1 England will win by 3 goals, or multiple events such as 20/1 England will win and Wayne Rooney will score the first goal. In any of these cases there is a point at which the outcome of the bet upon event is determinable. There is also a point in time where the event is in progress and either bets can still be placed or cannot, e.g. on Christmas day or after the start of the or at a predetermined period before the end of the game in h examples given above.

A bet can be placed on an event a long time in advance of the event. In the period after the placing of the bet and before the event occurs or ends, circumstances can cause the likelihood of the bet upon outcome of the event occurring to change e.g. due to injuries to players or a change in weather conditions. The event occurrence can become more likely and hence, in this case, the odds offered by bookmakers for new bets are reduced.

The auctioning of bets as auctions lots brings additional technical challenges to the implementation of an online auction system. Bets can be made on live events having a dynamic non-fixed end time. A bet can also be made on an event occurring before the termination of the live event, e.g. the first team to score a goal, try, touchdown etc. Bets can also be allowed to be made after the start of the event, during the event, termed in play, betting, with the odds offered for a bet dynamically changing with the state of play.

The marrying of the complexities of betting with the complexities of online auctions presents significant technical challenges.

### SUMMARY OF THE INVENTION

One aspect of the invention provides an apparatus for processing auction data, the system comprising a mass data store storing structured auction data defining the status of an auction; a temporary data store; a processor; and program memory storing processor implementable instructions, which when implemented by the processor, causes the processor to: receive bid data representing bids for an auction lot the subject of the auction; process and store the bid data in the mass data store to record the current confirmed status of the auction; receive event data representing an event during the auction that potentially closes the auction; after receiving the event data, cease processing and storing the bid data in the mass data store and store the bid data for any bids received after the event data in the temporary data store; receive event determination data indicating whether the event is confirmed or not; if the event determination data indicates that the event is not confirmed, process the bid data stored in the temporary data store, store the processed bid data in the mass data store to record and update the current confirmed status of the auction, and resume receiving, processing and storing the bids in the mass data store to record the current confirmed status of the auction; and if the event determination data indicates that the event is confirmed, update the status of the auction to closed.

Another aspect of the invention provides an apparatus for processing auction data, the system comprising a mass data store storing structured auction data defining the status of an auction; a temporary data store, the temporary data store having a faster data access speed than the mass data store; a processor; and program memory storing processor implementable instructions, which when implemented by the processor, causes the processor to: receive bid data representing bids for an auction lot the subject of the auction; store the bid data in the temporary data store; process the bid data and store the processed hid data in the mass data store to record the current confirmed status of the auction; generate auction status output data from the auction data stored in the mass storage device; store the auction status output data in the temporary data store; and generate auction user interface data using the auction status output data and the bid data stored in the temporary data store that has not yet been processed and stored in the mass data store.

Another aspect of the invention provides a computer implemented method of processing auction data using a mass data store storing structured auction data defining the status of an auction and a temporary data store, the method comprising receiving bid data representing bids for an auction lot the subject of the auction; processing and store the bid data in the mass data store to record the current confirmed status of the auction; receiving event data representing an event during the auction that potentially closes the auction; after receiving the event data, cease processing and storing the bid data in the mass data store and store the bid data for any bids received after the event data in the temporary data store; receiving event determination data indicating whether the event is confirmed or not; if the event determination data indicates that the event is not confirmed, processing the bid data stored in the temporary data store, storing the processed bid data in the mass data store to record and update the current confirmed status of the auction, and resuming receiving, processing and storing the bids in the mass data store to record the current confirmed status of the auction; and if the event determination data indicates that the event is confirmed, updating the status of the auction to closed.

Another aspect of the invention provides a computer implemented method of processing auction data using a mass data store storing structured auction data defining the status of an auction and a temporary data store, the temporary data store having a faster data access speed than the mass data store, the method comprising receiving bid data representing bids for an auction lot the subject of the auction; storing the bid data in the temporary data store; processing and storing the bid data in the mass data store to record the current confirmed status of the auction; generating auction status output data from the auction data stored in the mass storage device; storing the auction status output data in the temporary data store; and generating auction user interface data using the auction status output data and the bid data stored in the temporary data store that has not yet been processed and stored in the mass data store.

Another aspect of the invention provides a carrier medium, computer readable medium or a storage medium carrying code executable by a processor to carry out the deferred search method.

### BRIEF DESCRIPTION OF THE DRAWINGS

FIG. 1 is a schematic diagram illustrating a system for implementing an auction process;

FIG. 2 is a flow diagram illustrating a process of registering a user for an auction;

FIG. 3 is a flow diagram illustrating a process of listing a bet as an auction lot;

FIG. 4 is a flow diagram illustrating a process of an online auction;

FIG. 5 is a flow diagram illustrating steps in the flow diagram of FIG. 4 according to one embodiment;

FIG. 6 is a flow diagram illustrating steps in the flow diagram of FIG. 4 according to another embodiment;

FIG. 7 is an illustration of an example auction interface;

FIG. 8 is a flow diagram illustrating a simplified form of an auction according to one embodiment;

FIG. 9 is a flow diagram illustrating a simplified form of an auction according to another embodiment:

FIG. 10 is a diagram illustrating the data content of a temporary data store according to one embodiment;

FIG. 11 is a timing diagram of showing the storage of the hid data according to one embodiment;

FIG. 12 is a timing diagram of showing the storage of the bid data according to another embodiment;

FIG. 13 is a diagram illustrating an auction process with the auction closing; and

FIG. 14 is a block diagram illustrating a basic computing device.

### DETAILED DESCRIPTION

In the following detailed description, reference is made to the accompanying drawings that form a part hereof, and in which is shown by way of illustration specific embodiments in which the inventive subject matter may be practiced. These embodiments are described in sufficient detail to enable those skilled in the art to practice them, and it is to be understood that other embodiments may be utilized and that structural, logical, and electrical changes may be made without departing from the scope of the inventive subject matter. Such embodiments of the inventive subject matter may be referred to, individually and/or collectively, herein by the term “invention” merely for convenience and without intending to voluntarily limit the scope of this application to any single invention or inventive concept if more than one is in fact disclosed.

The following description is, therefore, not to be taken in a limited sense, and the scope of the inventive subject matter is defined by the appended claims.

In the following embodiments, like components are labelled with like reference numerals.

In the following embodiments, data is described, as being stored in at least one database. The term database is intended to encompass any data structure (and/or combinations of multiple data structures) for storing and/or organizing data, including, but not limited to, relational databases (e.g., Oracle databases, mySQL databases, etc.), non-relational databases (e.g., NoSQL databases, etc.), in-memory databases, spreadsheets, as comma separated values (CSV) files, eXtendible markup language (XML) files, TeXT (TXT) files, flat files, spreadsheet files, and/or any other widely used or proprietary format for data storage. Databases are typically stored in one or more data stores. Accordingly, each database referred to herein (e.g., in the description herein and/or the figures of the present application) is to be understood as being stored in one or more data stores. A “file system” may control how data is stored and/or retrieved (for example, a disk file system like FAT, NTFS, optical discs, etc., a flash file system, a tape file system, a database file system, a transactional file system, a network file system, etc.). For simplicity, the disclosure is described herein with respect to databases. However, the systems and techniques disclosed herein may be implemented with file systems or a combination of databases and file systems.

In the following embodiments, the term data store is intended to encompass any, computer readable storage medium and/or device (or collection of data storage mediums and/or devices). Examples of data stores include, but are not limited to, optical disks (e.g., CD-ROM, DVD-ROM, etc.), magnetic disks (e.g., hard disks, floppy disks, etc.), memory circuits (e.g., solid state drives, random-access memory (RAM), etc.), and/or the like. Another example of a data store is a hosted storage environment that includes a collection of physical data storage devices that may be remotely accessible and may be rapidly provisioned as needed (commonly referred to as “cloud” storage).

The functions or algorithms described herein are implemented in hardware, software or a combination of software and hardware in one embodiment. The software comprises computer executable instructions stored on computer readable carrier media such as memory or other type of storage devices. Further, described functions may correspond to modules, which may be software, hardware, firmware, or any combination thereof. Multiple functions are performed in one or more modules as desired, and the embodiments described are merely examples. The software is executed on a digital signal processor, ASIC, microprocessor, or other type of processor operating on a system, such as a personal computer, server, a router, or other device capable of processing data including network interconnection devices.

Some embodiments implement the functions in two or more specific interconnected hardware modules or devices with related control and data signals communicated between and through the modules, or as portions of an application-specific integrated circuit. Thus, the exemplary process flow is applicable to software, firmware, and hardware implementations.

A generalized embodiment provides a method and apparatus at or comprising one or more servers or computers having a mass data store storing structured auction data defining the status of an auction and a temporary data store. Bid data is received from client computers operated by users (bidders) representing bids for an auction lot the subject of the auction. The bid data is processed and stored in the mass data store to record the current confirmed status of the auction. If event data is received representing an event during the auction that potentially closes the auction, the processing and storing of the hid data in the mass data store ceases and the bid data for any bids received after the event data is stored in the temporary data store. When event determination data indicating whether the event is confirmed or not is received, if the event determination data indicates that the event is not confirmed, the bid data stored in the temporary data store is processed, the processed bid data is stored in the mass data store to record and update the current confirmed status of the auction, and the reception, processing and storing of the bids in the mass data store to record the current confirmed status of the auction is resumed. If, however, the event determination data indicates that the event is confirmed, the status of the auction is updated to closed.

The event data represents data on an event that is external to the auction. In an embodiment in which the auction lot is a bet, the event data represents data on the outcome on which the bet has been placed. The event can comprise the occurrence of something during an overall event. For example, the overall event can be a game, match, race etc. The event during the overall event can comprise a goal in a football match, a try in a rugby match, a touchdown in an American football game, a wicket in a cricket match, a horse falling at a fence in a horse race, etc. Hence, a user may have a bet on the overall outcome of the event or an interim event before the overall outcome of the event. The end of the overall event is deterministic, when the final time is up, the final whistle is blown, or the race is finished and hence bets placed on such events usually have a determined end. However, there may be times when the end of the overall event is not confirmed immediately. For example, a photo finish at the end of a race may require time for the judges to analyze. For events bet on to occur during an overall event, the determination of the event being confirmed is often immediate. For example, a goal in a football match that a referee allows initially may be disallowed e.g. for offside or a try in rugby may be disallowed on video evidence analysis by the fourth official. This period of uncertainty presents technical timing issues for the processing of data if an auction process is to be allowed during the overall event up to occurrence of the bet upon event.

Event data is often provided as a data feed from a data source and such a source of data may provide initial event data indicating the occurrence of the event on a provisional or unconfirmed basis, followed by event confirmation data either as confirmation that the event occurred and the event data is valid or an indication that the event data not confirmed and hence is invalid.

By storing the bid data in a temporary data store in a form that is not processed or at least not fully processed after receipt of tire event data and before receipt of the event confirmation data, if the event confirmation data indicates that the event is confirmed, the need for technically complex database roll back procedures in order to remove any bid data that was received and processed into tire confirmed auction status data after receipt of the event data and before confirmation of the event is avoided.

The storage of the bid data after the receipt of the event and before the receipt of the event confirmation data avoids the need for unnecessary processing of bid data that might not be required as well as avoiding the need to remove it from the auction status data in a rollback operation if the event is not confirmed. If the event is not confirmed and the auction needs to resume, any bids received after receipt of the event data and before receipt of the event confirmation data can then be processed to be included, in the processed structured auction data in the mass data store. So, while the event is unconfirmed, the confirmed auction status reflects the highest bidder as the highest bidder at the time of receipt of the event data.

In one embodiment, the event can comprise an event internal to the auction such as a selection by a user of an option of a ‘buy-it-now’ price or a bid that is equal to or more than the buy-it-now price. On the occurrence of such an event, the event is required to be validated or confirmed e.g. by confirming that the user has credit or the means to pay the price. Hence, the confirmation delay in such an example can be due to financial checking internally or with reference to a financial institution. While this checking is going on, bids received from other bidders after the user selection of the buy-it-now option are temporarily stored to either be ignored if the user selection is validated or processed into the confirmed auction data in the mass data store if the user selection is not validated. This avoids the loss of potentially valid bids while avoiding the need to process them into the confirmed auction status data during the validation period.

Whether the event is internal or external to the auction, the occurrence of the event signified by the receipt of the event data requires the processing of later received bid data to be suspended pending the determination of whether or not the event is valid.

When event data is received, the auction processing can utilize a temporary data store until this potential end of auction is confirmed. The use of the temporary data store in this manner allows for efficient processing of auction data for bids received during an overall event i.e. to allow for ‘in play’ auction bidding.

Although embodiments have been described with reference to the auctioning of auctions lots in the form of bets, embodiments are not restricted to the auction lot being a bet. Where the event is an internal auction event, such as a buy-it-now input, the auction lots can comprise any commodity (product or service).

The received bid data can be processed and stored directly into the mass data store to update the current status of the auction as the auction bids are received and then when event data is received, bid data received after the receipt of the event data can be stored in the temporary data store pending determination of whether or not the event is valid. If the event is determined to be valid, the bid data stored in the temporary data store is either deleted or stored in the mass data store in a manner that does not update the status of the auction. In this way, the late entered bid data can be stored for auditing purposes.

The received bid data can be stored in the temporary data store as it is received and the data can be processed and stored in the mass data store. The storage in both the temporary data store and the mass data store can be performed in parallel by the software operating on the server/computer or serially so that the data is first stored in the temporary data store and then read, processed and stored into the mass data store.

The processing of the received bid data can be delayed for a period to delay updating the status of the auction data in the mass data store. The delay can be provided for by the storing of the bid data either in an unprocessed form or in a partially processed form in a memory such as the temporary data store or a separate buffer. The reason for the delay is to allow for delays in the receipt of the event data. Where the event data is provided from an input external to the auction system, there may be transmission delays incurred by the event data. For example, where the auction lot is a bet and the event data is an event on which the bet was placed, the delayed processing enables the processing of bid data for a period prior to the receipt of event data to be prevented in order to prevent the receipt of bets after the occurrence of the event, e.g. where users are watching the event live and have a fast internet connection that could enable them to watch the event and cause bet data to be transmitted to the auction system prior to the event data reaching the auction system

The temporary data store can comprise any fast, non-persistent input output data store such as volatile memory, solid state memory, cache, etc., which has a faster access speed than the mass data store, which can comprise persistent data, a mass storage device, a database etc. The use of the fast, temporary data store in conjunction with the slower mass data store holding the auction status data enables the system to overcome timing issues with input bid data and outputs displayed auction status data. The use of the term ‘fast’ or ‘faster’ in this disclosure need not mean that the temporary data store is faster than the mass data store based on inherent properties of the data stores. It can be faster simply because of the way it is used. For example, the temporary data store and the mass data store can be hosted on the same hardware or even software technology, such as the same database (e.g. SQL database), but with different functionality or implementation to affect the different speeds. For example, in an SQL database, the temporary store faster can be made faster by turning off transaction logging for certain tables, or otherwise tuning performance. The temporary store could be faster just because it performs less processing per transaction than the mass data store.

To provide an auction interface to enable users to input bid data, auction status output data can be generated using the data in the mass data store and the generated auction status output data can be stored in the temporary data store to provide fast access. The auction user interface data for generating an auction user interface on a user's computer can be generated using the stored auction status output data and the bid data stored in the temporary data store that has not yet been processed and stored in the mass data store. In this way, any, bids which have recently been received but have not yet been processed into the confirmed status of the auction in the mass data store can be displayed to a user.

The use of a temporary fast memory can enable bid data to be stored to before or during processing to avoid bids being processed after the event or after the event data is received. Also, the fast-temporary memory can provide a cache for the generation of the auction user interface, which can be supplemented with bid data for bids not yet processed into the confirmed auction data.

Another generalized embodiment provides a method and apparatus at or comprising one or more servers or computers having a mass data store storing structured auction data defining the status of an auction and a temporary data store. Bid data is received from client computers operated by users (bidders) representing bids for an auction lot the subject of the auction. The bid data is stored in the temporary data store. The stored bid data is processed and stored in the mass data store to record the current confirmed status of the auction. To generate an auction user interface auction status output data is generated from the auction data stored in the mass storage device and stored in the temporary data store. Auction user interface data is then generated using the auction status output data and the bid data stored in the temporary data store that has not yet been processed and stored in the mass data store. In this way, any bids which have recently been received but have not yet been processed into the confirmed status of the auction in the mass data store can be displayed to a user.

Specific embodiments will now be described with reference to the accompanying drawings.

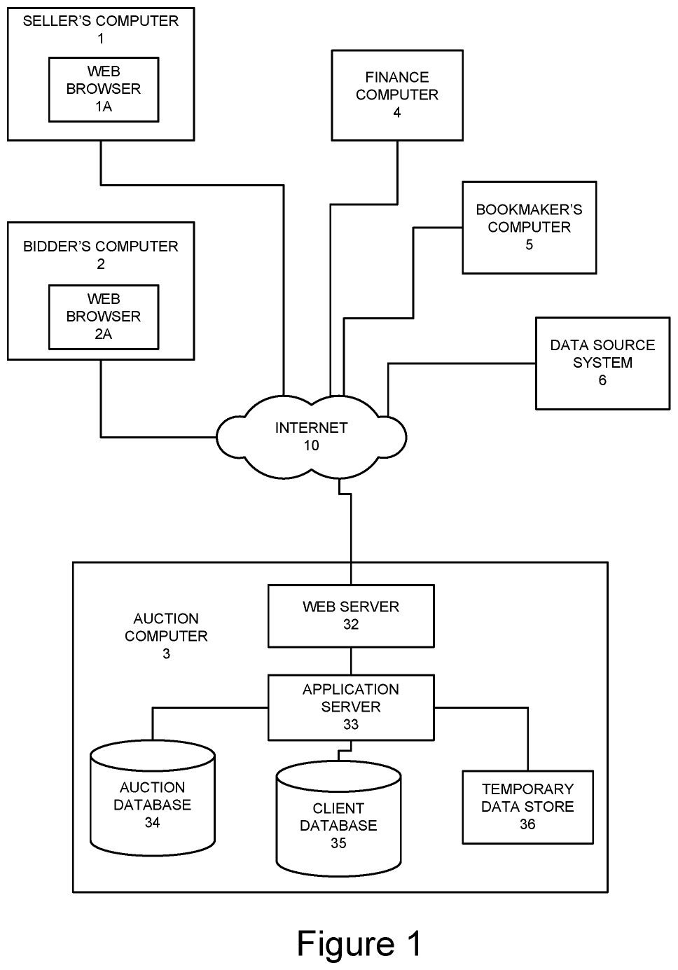

A first embodiment will be described with reference to FIGS. 1 to 4. FIG. 1 illustrates an auction system of one embodiment for implementing an electronic bet auction process.

An auction computer 3 is connected to a seller's computer 1 and a bidder's computer 2 over the internet 10. The internet 10 is a convenient network. However, any suitable communications network can be used such as a local area network, a wide area network, a mobile communications network, WiFi, Bluetooth etc. The auction computer 3 is also connected over the internet 10 to a finance computer 4 operated by a third party financial institution and to a bookmaker's computer 5 operated by a bookmaker who supplied the bet. Although only a single finance computer 4 and a single bookmaker's computer 5 is illustrated, multiple such computers can be provided operated by multiple finance institutions and bookmakers respectively. Further, the finance computer 4 and the bookmaker's computers 5 can be unified in an embodiment where the functions of the bookmaker and the financial services are provided by a single entity.

A data source 6 is connected to the internet 10 to provide a source of event data and event determination data for the auction computer 3. The data source 6 can also provide a stream of live video data and other event data for specific events and the overall events which can be the subject of bets comprising auction lots. For example, the data source can provide a video streams of sporting events and data on the event including event data.

The seller's computer 1 implements a web browser 1A in software to access the functionality of the auction computer 3. Similarly, the bidder's computer 2 implements a web browser 2A in software to access the functionality of the auction computer 3.

The auction computer 3 comprises a web server 32 for serving web pages for rendering by the web browsers 1A and 2B of the seller's computer 1 and the buyer's computer 2 respectively. The main functions of the auction computer 3 are in this embodiment performed by an application server 33, which accesses an auction database 34, a client database 35 and a temporary data store 36. The functionality of the auction computer 3 can be provided alternatively by any suitable software and hardware combination including multiple hardware servers and alternative software such a Microsoft Service.

The auction database 34 comprises a mass data store in which structured data is stored defining the confirmed status of the auction. The access speed to the auction database 34 is slow compared with the access speed of the temporary data store 36. The temporary data store 36 can comprise a solid-state memory which can be volatile to provide fast access to bid data in an unstructured form or a form having a low structure that has been processed only to a limited degree.

API interfaces (not shown) can also be provided by the auction computer 3 to allow the data source system 6, the bookmaker's computer 5 and the finance computer 4 to access the application server 33 for data reception and the transmission and reception of data between them.

As an alternative to using a web browser 1A and 2A, the bidders and sellers/listers could access the service of the auction computer using a mobile device as the seller's and bidder's computers 1 and 2 and a bespoke application e.g. a mobile phone app.

In an alternative embodiment, the functionality of the auction computer 3 could be combined with the bookmaker's computer 5 and the finance computer 4 by a single service provider. Alternatively, just the functionality of the auction computer 3 and the bookmaker's computer 5 could be combined by a single service provider.

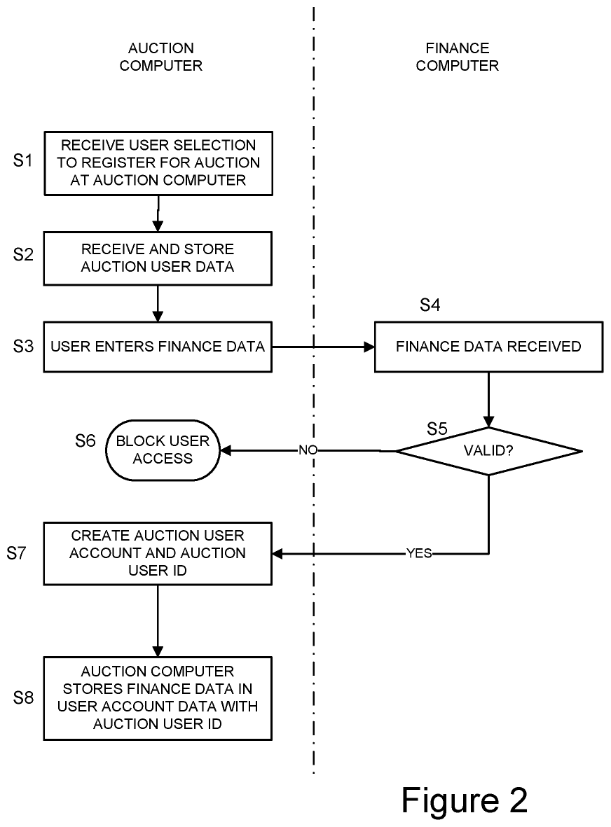

FIG. 2 illustrates a process for the registration of a user for use of the auction service, either as a seller or as a bidder. The registration process is performed by the cooperation of the auction computer 3 and the finance computer 4 or a combined service provider's computer in an alternative embodiment. The process enables the identity and credit status of a user to be checked for the setting up of an account in the auction system.

In step S1 the auction computer 3 receives a user selection to register for the auction service via a web site hosted by the web server 32. The web server 32 provides a registration page on which the user can enter auction user data (step S2). The user also enters financial data in step S3 which enables the auction computer 3 to access a financial record in a finance computer 4 operated by a financial institution. The financial institution can comprise a payment service such as PayPal or WorldPay, a bank, or a credit card company. The financial data entered by the user is received by the finance computer 4 in step S4 to enable it to perform validation and credit checks (step S5). Such checks can comprise simply accessing a user's account using the access information passed to the finance computer 4. Alternatively, to avoid sensitive information being handled by the auction computer 3, in steps S3 and S4 a user is redirected to the finance computer 4 to log into their account for validation and credit checks in step S4. The finance computer 4 will transmit the result of the validation check to the auction computer 3. If the validation check fails, the auction computer 3 blocks access to the auction service in step S6. If the validation check is successful, the auction computer 3 creates an auction user account with an auction user identifier (ID) in step S1. The finance data enabling the auction computer 3 to link with the finance computer 4 is then stored in the user account data with the auction user ID in step S8.

The auction user data stored in the client database 36 hence comprises at least the username, password, auction user ID, email address and finance data.

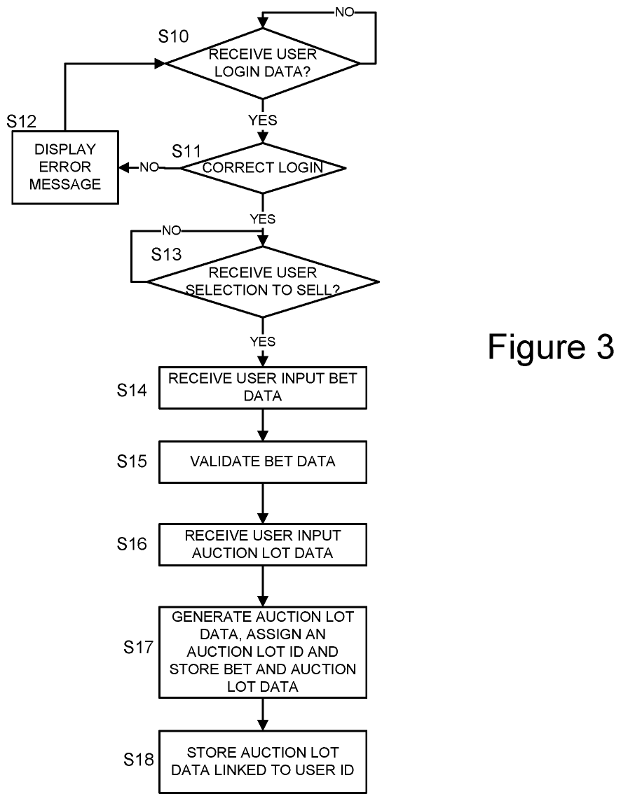

FIG. 3 is a flow diagram illustrating the process of listing a bet in an auction according to an embodiment.

In step S10 the web server 32 serves a login web page to the web browser 1A of the seller's computer 1 and waits for the seller to login with their username and password. If the login data is incorrect (step S11) an error message is generated as a web page or part and displayed on the web browser 1A of the seller's computer 1 (step S12) and the process returns to step S10. If the login data is correct (step S11) the web server 32 generates a web page allowing the seller to input a selection to sell a bet and the process waits for a user selection (step S13). When a user selection is made in step S13, the web page captures the seller's input bet data in step S14. The web page can provide predefined options for the entry of bet data to enable the seller to select from the options. These options are based on a database of future events and event outcomes that the system can have access to. For example, the seller can select a sport and the options will then be displayed to select an event e.g. horse racing and Cheltenham Gold Cup 12 May 2014. The web page can then display the betting options including the event outcome in the form of a horse name, the type of bet e.g. win, place or each way, and the stake. The use of the options provides a simple form of validation of the bet i.e. there is an event an event outcome for the bet being entered into the auction. The seller can also be allowed to enter the data manually but the data may be flagged to indicate this. The bet data can also include events outcomes that occur during an overall event before the overall event outcome, such as first goal, try by Mike Jones etc.

In step S15 the input bet data is validated by reference to data held by the bookmaker's computer 5. If the bet data is not valid, the process goes not further. The user is notified and can re-enter or correct the entered bet data.

In step S16 a web page or part is generated to enable a user to input user auction lot data. Such data can comprise descriptive data, contact information, an end date and time for the auction as desired by the seller, and a starting price for the bet, which can be set at the price of the stake or at no minimum starting price for example. In step S17 auction lot data is generated for the auction item, an auction ID is assigned and the bet data and the auction data are stored. The bet data comprises a bet ID, data identifying the outcome of the event (event name, location, date and time, event outcome, value of bet (stake), the odds, the type of bet e.g. win, place or each way, bookmaker information (ID, name, branch, reference), and auction user ID (seller ID). The auction data is generated to comprise the auction ID, the bet ID, and an end date and time, which can be defined by or relative to the end of an event. The auction data will also include bid Ms when bids are received for the auction item. The auction end date and time can be automatically generated with reference to the event date and time to ensure that the auction end time is in advance of the occurrence of the auction event. Alternatively, the system can allow the seller to enter an auction end date and time as part of the user input of the user input auction data in step S16. For in-play auctions, based on live data from a data source 6, the auction end date and time will be based on the date and time at which the overall event concludes. This will be signaled by receipt of event data from the data source 6. Also, an auction end can be forced based on an in-play event occurring and being signaled by event data and confirmed by event determination data.

In step S18 the auction lot data is stored linked to the user ID. The bet listing process is thus complete.

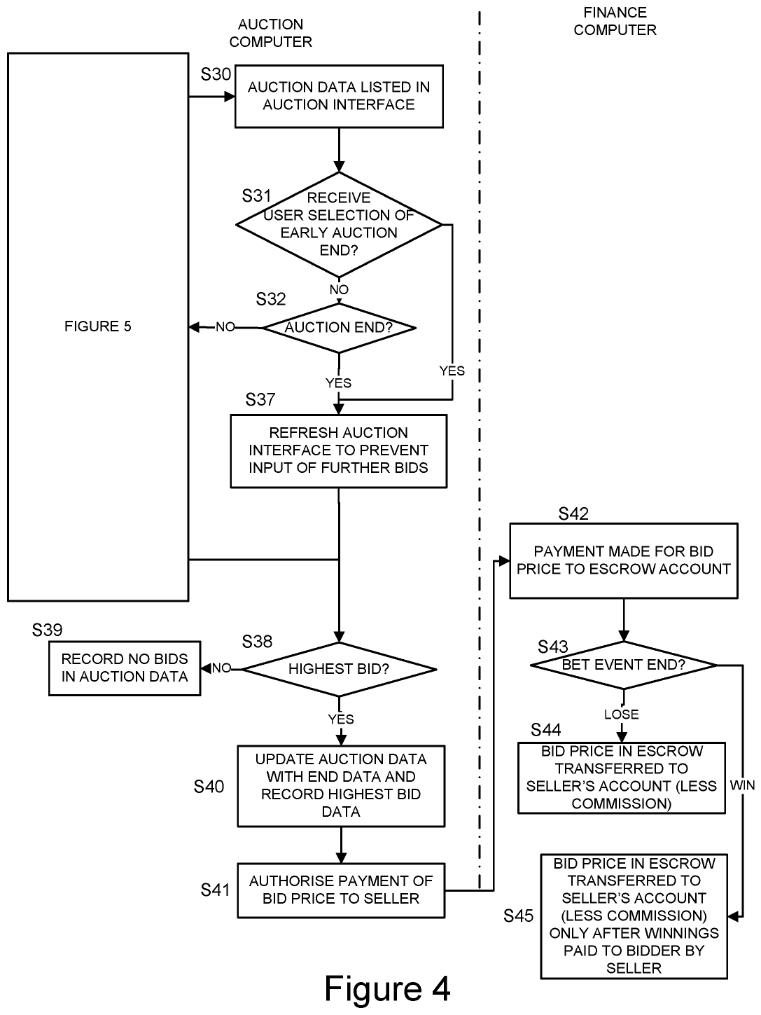

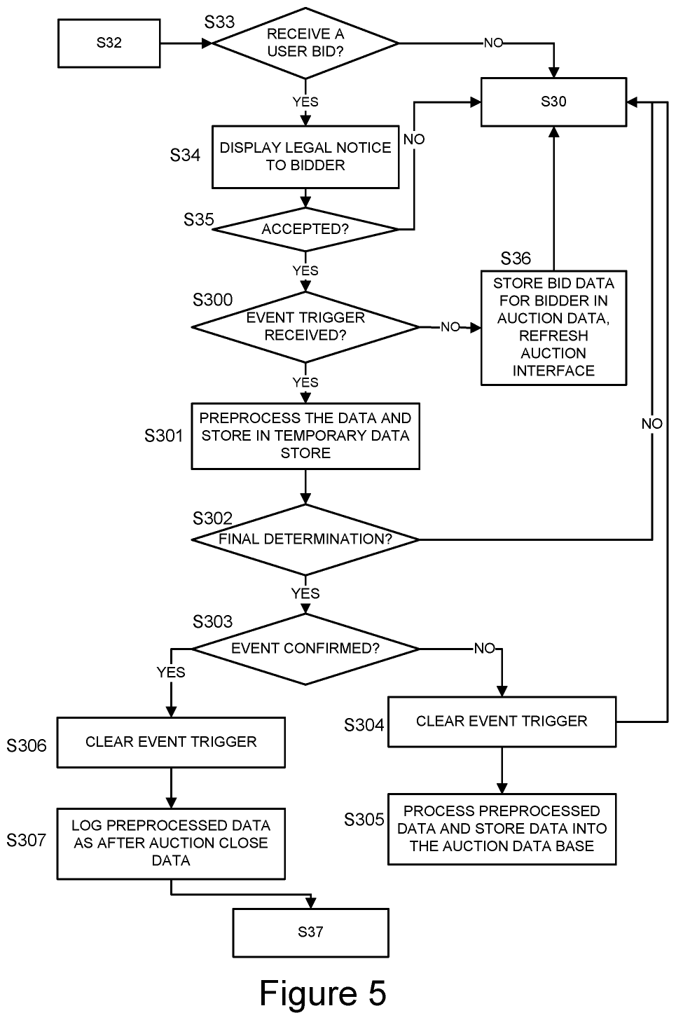

FIGS. 4 and 5 are a flow diagrams illustrating the process for the auctioning of a bet in accordance with one embodiment.

In step S30 the web server 32 generates a web page as an auction interface listing one or more auction items comprising bets listed as auction lots by sellers. The process will be described with reference to the display of only one auction lot or item. The item is listed in an auction until the end of the auction. The listing of each bet as an auction item comprises displaying the bet information. In step S31, at any point in the auction in this embodiment, a seller can make a selection using the interface to end the auction early. This could be to withdraw the bet from the auction or to accept the current highest bid. If the user has not selected to end the auction early in step S31, the process determines whether the date and time match the date and time set in the auction data for the end of the auction (step S32) or if the data source has sent event data indicating the end of the overall event.

If not (step S32), the auction process waits to receive bids in step S33 and if none are received it returns in a loop back to step S30. If a bid is input by a bidder (step S33), the web server 32 generates a legal notice as a web page or part for display by the web browser 2A of the bidder's computer 2 (step S34). If the user does not select to accept the terms and conditions of the legal notice (step S35), the process loops back to step S30. If the user selects to accepts the terms and conditions in step S35 it is determined whether an event trigger has been received in event data front the data source 6. If not, in step S36 bid data is processed and stored for the bidder in the auction data in the mass data store and the auction interface is refreshed to show the current bid state for the auction item. The auction interface is refreshed by generating updated auction status output data and storing it in the temporary data store 36 for fast access by the seller's and bidder's computers 1 and 2. The bid data comprises the auction ID, the bid value, date and time, and the auction user ID. The process then loops back to step S30 to repeat.

If in step S300 it is determined that event trigger data has been received in event data from the data source 6, received bid data for bids received after the trigger are preprocessed to a simple data structure and stored in the temporary data store 36 in step S301. If event determination data has not been received from the data source 6 giving a final determination on whether the event is valid (step S302), the process returns to step S30. If the event determination data has been received (step S302), it is determined whether the event determination data confirms or validates the event data or not in step S303. If the event determination data identifies that the event data is not confirmed in step S303, then the auction is not going to close and in step S304 an event trigger stored after receipt of the event data to indicate that the event is pending conformation is deleted and the data stored in the temporary data store 36 is processed and stored into the auction database 34 in step S305. The process then returns to step S30 to continue with the auction for the receipt of further bid data is preprocessed to a simple data structure and stored in the temporary data store.

If in step S303 that the event determination data indicates that the event data is confirmed, in step S306 the event trigger stored after receipt of the event data to indicate that the event is pending conformation is deleted and in step S307 the data stored in the temporary memory is logged in the auction database as bid data received after the close of the auction. The process then proceeds to step S37 in FIG. 4.

In an alternative embodiment, the data stored in the temporary data store 36 is deleted. The benefit of keeping a log of any bid data received after the close of the auction is that it can be used for audit purposes, such as reviewed in the event of any dispute. It may also be required for regulatory reasons.

At the end of the auction (step S37) the auction interface provided by the web server 32 is refreshed to show the end status of the auction to bidders and the sellers. The process then determines if there is a highest bid i.e. any bid above the reserved minimum price set by the seller (step S38). If not a record of no bids is stored in the auction data (step S39) and the process for the auctioning of the bet is finished.

If there is a hid above the minimum set by the seller (step S38), the auction data is updated with end of auction data including a record of the highest bid and the auction end date and time (step S40). The auction record can include a record of all bids for the auction item (bet). Payment of the bid price to the seller by the finance computer 4 is then authorized in step S41 by the auction computer 3. In step S42 the payment computer makes an electronic payment of the highest bid price from the account of the highest bidder into a holding or escrow account. The money will stay in this account until the bet event outcome (step S43), If the bet loses, the highest bid price paid by the highest bidder held in the holding or escrow account is transferred to the seller's account less commission charges by the auction operator and possibly by the financial institution (step S44). If the bet wins, the highest bid price paid by the highest bidder held in escrow is transferred to the seller's account less commission charges by the auction operator and possibly by the financial institution only after the winnings are paid by the seller to the highest bidder (step S45). This provides the bidder with some comfort that if the seller does not pay the winnings at least they can get their bid back from the escrow account.

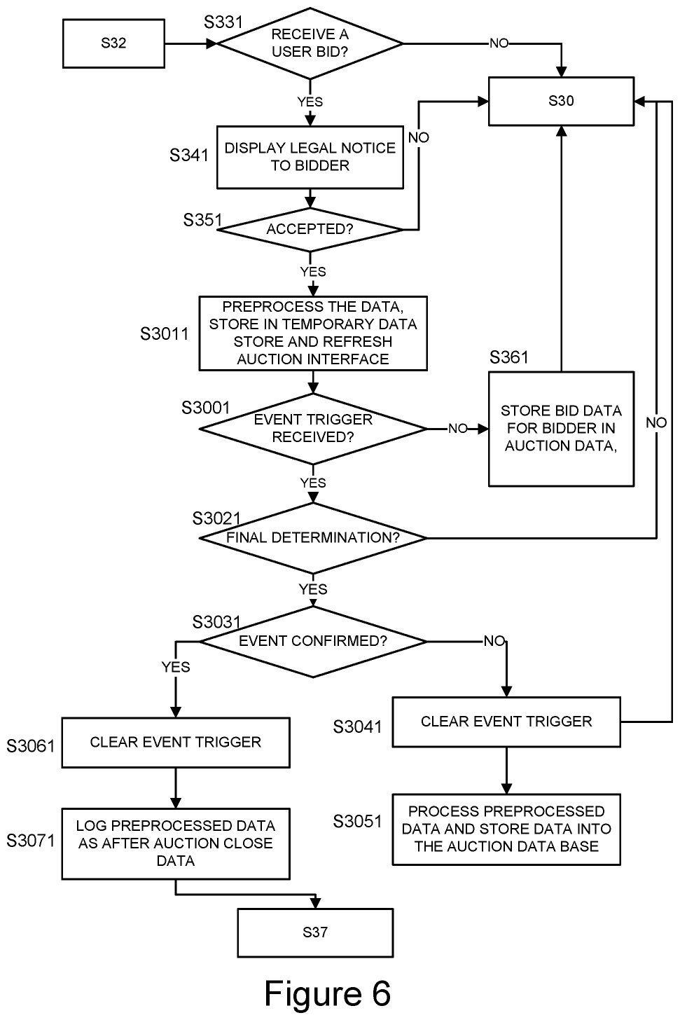

FIG. 6 is a flow diagram of an alternative process to the process illustrated in the flow diagram of FIG. 5

From step S32 in FIG. 4, the auction process in this embodiment waits to receive bids in step S331 and if none are received it returns in a loop back to step S30. If a bid is input by a bidder (step S331), the web server 32 generates a legal notice as a web page or part for display by the web browser 222A of the bidder's computer 2 (step S341). If the user does not select to accept the terms and conditions of the legal notice (step S351), the process loops back to step S30. If the user selects to accepts the terms and conditions in step S351, received bid data for the received bids is preprocessed to a simple data structure and stored in the temporary data store 36 in step S3011 and the stored bid data is used to refresh the auction interface. The process then determines whether an event trigger has been received in event data from the data source 6 in step S3001. If not, in step S361 the bid data stored in the temporary data store is processed and stored for the bidder in the auction data in the mass data store 34 . . . . The process then loops back to step S30 to repeat.

If in step S3001 it is determined that event trigger data has been received in event data from the data source 6, it is determined whether event final determination data has been received in step S3021. If the event determination data has not been received from the data source 6 giving a final determination on whether the event is valid in step S3021, the process returns to step S30. If the event determination data has been received (step S3021), it is determined whether the event determination data confirms or validates the event data or not in step S3031. If the event determination data identifies that the event data is not confirmed, then the auction is not going to close and in step S3041 an event trigger stored after receipt of the event data to indicate that the event is pending conformation is deleted and the data stored in the temporary data store 36 is processed and stored into the auction database 34 in step S3051. The process then returns to step S30 to continue with the auction for the receipt of further bid data is preprocessed to a simple data structure and stored in the temporary data store.

If in step S3031 that the event determination data indicates that the event data is confirmed, in step S3016 the event trigger stored after receipt of the event data to indicate that the event is pending conformation is deleted and in step S3071 the data stored in the temporary memory is logged in the auction database as bid data received after the close of the auction. The process then proceeds to step S37 in FIG. 4.

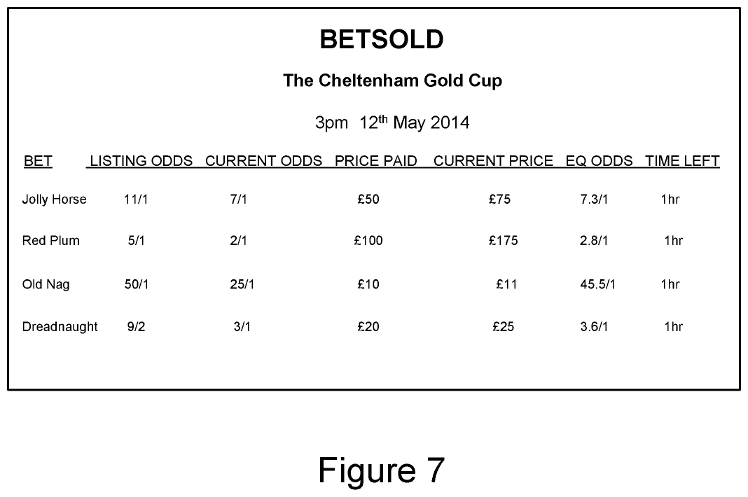

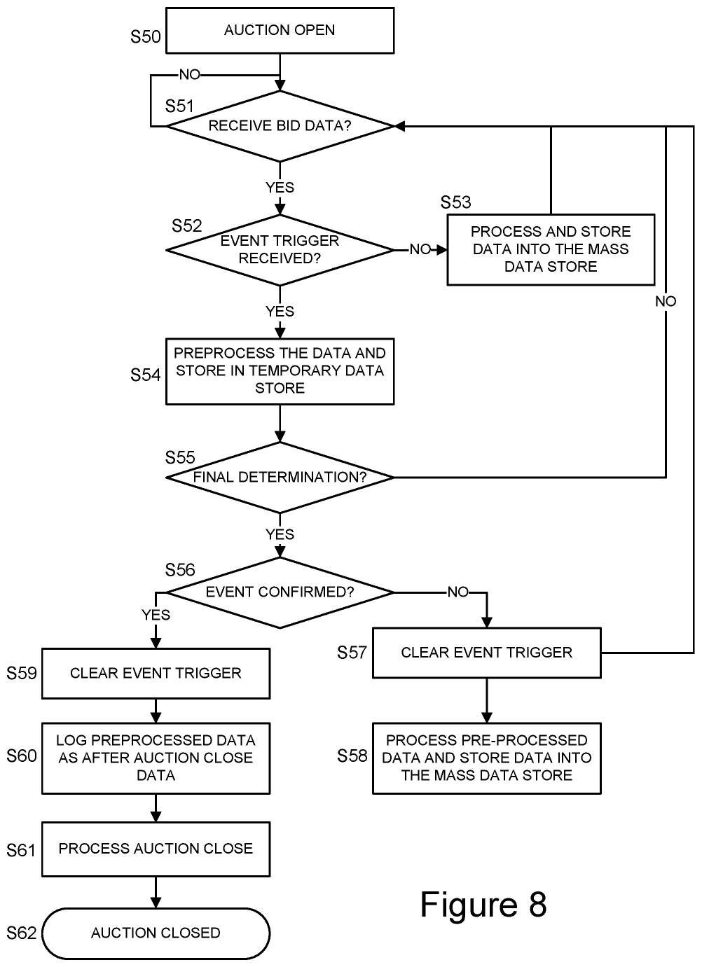

FIG. 7 illustrates an auction interface generated by an auction computer according to one embodiment of the invention. The auction process can comprise the auction process described with reference to FIGS. 1 to 6 or with reference to any of FIGS. 8 to 14 herein after. The interface can be generated by a server and transmitted to a bidder's computer acting as a client computer. In one embodiment, the interface can be provided as a web page or part by a web server such as the web server 32 of FIG. 1 for display on a web browser such as the web browser 2A of FIG. 1.

As can be seen in FIG. 7, bets are displayed for the outcome of an event, which in this example is a horse race. The name of the event and the date and time are displayed. For each bet, the bet data is displayed which comprises the event focus i.e. the horse name, the listing odds which comprise the odds at the time the bet was placed, the current odds offered externally, the price paid i.e. the stake, the current hid price, the equivalent odds, and the time left until the end of the auction for the bet. The display of the original odds at which the bet was placed and the current odds enables a potential bidder to easily determine if the odds have improved and whether it is worth bidding for the bet. To further inform the potential bidder, the application server 33 calculates the equivalent odds for the current bid price. The equivalent odds are calculated by determining the bet value if won, which for Jolly Horse is 11/1*£50=£550 and then dividing by the current price £75. This gives an equivalent odd of 7.3/1. This indicates the current odds that would be required to achieve the same winning price. It can be see that the current odds offered by the bookmakers are 7/1. Hence, the current bid price for the bet is only able to achieve a potential win value slightly higher than can be achieved by placing a bet with the bookmakers at the current odds. However, if the auction data for Old Nag are considered, it can be seen that the equivalent odds are 45.5/1 as compared with the current odds offered by the bookmakers of 25/1. Hence, purely considering the odds, this might be an attractive bet to hid for with a potential high comparative return.

The current odds displayed in FIG. 7 are offered by external entities in two forms, namely as fixed odds (an ante post bet) in advance of the event and todays (live) odds, which are offered on the day of the event or during the event for some type of events. The external entities can comprise a single bookmaker or bookmaker company, a group of bookmakers, or some other odds providing entity, Such an odds providing entity can take the odds from bookmakers and generate a compilation, such as an average of the odds offered externally. For a fixed odds bet the risk to the bidder can be higher due to events, which can occur prior to the event to change the outcome of the event. For example, in horse racing a bidder may have place a bet on a horse that is withdrawn from the race. The odds available to the bidder change from the fixed odds to the live odds at a predetermined period before the event or at the start of the event. In the prior art bookmakers and other odds setting entities keep the data for the two types of odd separate. The current odds used in this embodiment are a combination based on the two types of external odds. The system takes two separate data feeds from the bookmakers, or odds providing entity; one for the fixed odds and one for the live odds. The current odds displayed are the odds available to a potential bidder in the external market at the time they view the display. Hence, the feeds from the odds provider need to be real time or near real time to avoid the current odds being out of date.

The bid data creates internal market prices and based on the bookmakers odds feed, displaying (external) market prices in comparison to internal market prices (where the perceived internal market price is directly influenced by the external market)

In order to place a bid for a bet (auction item) a bidder can select the horse by for example clicking on it using a pointer, hand-held device or touching the screen of a touch screen. A bid entry interface will then be displayed to the bidder by the auction computer 3 e.g. as a web page served by the web server 32, to enable the entry of bid data.

FIG. 8 is a flow diagram illustrating a simplified form of an auction according to one embodiment.

In step S50 the auction process starts and in step S51 the auction process waits to receive hid data. If none, is received the process waits in a loop. If bid data is received in step SM, the software determines whether an event trigger has been received in event data. If not, in step S53 bid data is processed and stored in the mass data store. The process then loops back to step S51 to repeat.

If in step S52 it is determined that event trigger data has been received in event data, received bid data for bids received after the trigger are preprocessed to a simple data structure and stored in the temporary data store in step S54. It is then determined whether event determination data has been received (step S55). If the event determination data has not been received in step S55, the process returns to step SM. If the event determination data has been received in step S55 it is determined whether the event determination data confirms or validates the event data or not in step S56. If the event determination data identifies that the event data is not confirmed, then the auction is not going to close and in step S57 an event trigger stored after receipt of the event data to indicate that the event is pending confirmation is deleted and the data stored in the temporary data store is processed and stored into the mass data store in step S58. The process then returns to step S51 to continue with the auction for the receipt of further bid data.

If in step S56 it is determined that the event determination data indicates that the event data is confirmed, in step S59 the event trigger stored after receipt of the event data to indicate that the event is pending is deleted and in step S60 the data stored in the temporary memory is logged in the mass data store as bid data received after the close of the auction. In step S61 the auction closing is processed and in step S62 the auction is closed.

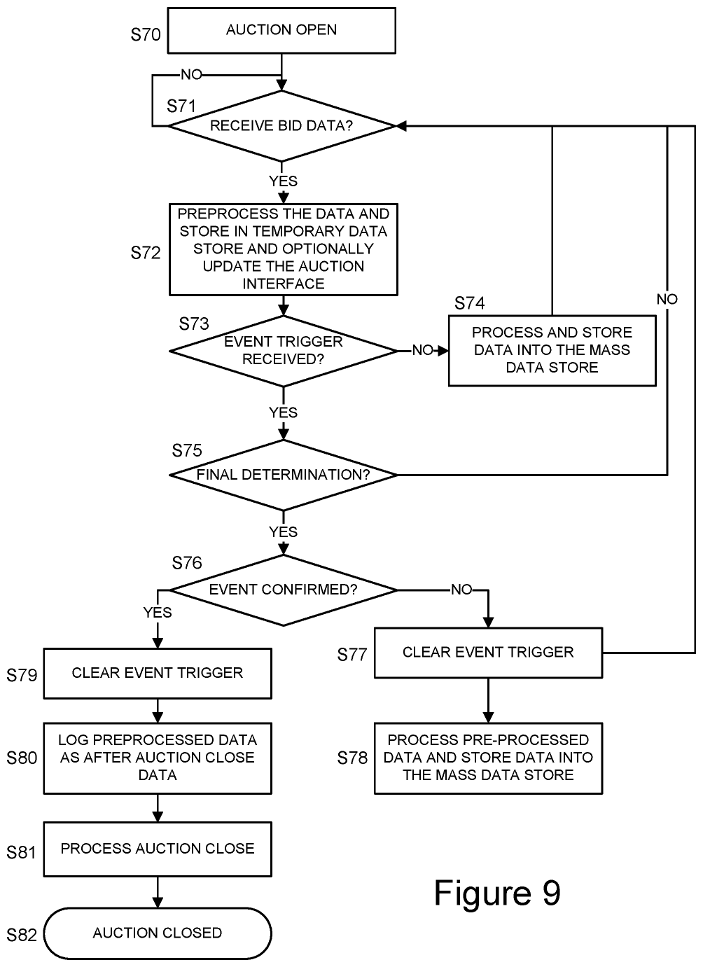

FIG. 9 is a flow diagram illustrating a simplified form of an auction according to another embodiment.

In step S70 the auction process starts and in step S71 the auction process waits to receive bid data. If none is received the process waits in a loop. If bid data is received in step S71, the software received bid data for received bids are preprocessed to a simple data structure and stored in the temporary data store in step S72. Also, the auction interface can optionally be updated to include the received bid data that has not yet been processed into confirmed auction status data in the mass data store. The process then determines whether an event trigger has been received in event data in step S73. If not, in step S74 bid data is processed and stored in the mass data store. The process then loops back to step S71 to repeat.

If in step S73 it is determined that event trigger data has been received in event data, it is then determined whether event determination data has been received (step S75). If the event determination data has not been received in step S75, the process returns to step S81S71. If the event determination data has been received in step S75 it is determined whether the event determination data confirms or validates the event data or not in step S76. If the event determination data identifies that the event data is not confirmed, then the auction is not going to close and in step S77 an event trigger stored after receipt of the event data to indicate that the event is pending conformation is deleted and the data stored in the temporary data store is processed and stored into the mass data store in step S78. The process then returns to step S71 to continue with the auction for the receipt of further bid data.

If in step S76 it is determined that the event determination data indicates that the event data is confirmed, in step S79 the event trigger stored after receipt of the event data to indicate that the event is pending is deleted and in step S80 the data stored in the temporary memory is logged in the mass data store as bid data received after the close of the auction. In step S81 the auction closing is processed and in step S82 the auction is closed.

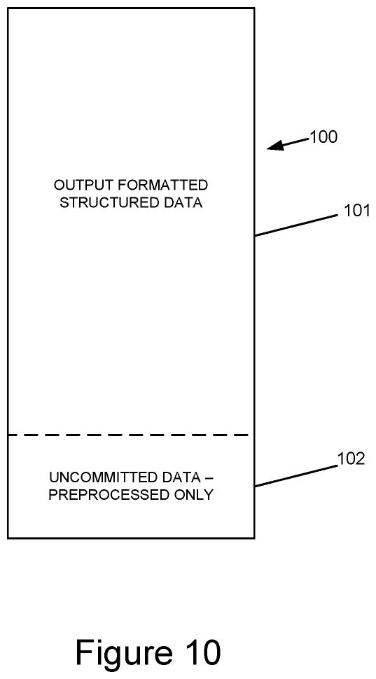

FIG. 10 is a diagram illustrating the data content of a temporary data store 100, such as the temporary data store 36 in FIG. 1. The temporary data store can act as a cache for data into and out of the mass data store and provides a cache for use in generating a fast auction interface for access by user's computers.

The stored data comprises output formatted structured data 101 comprising the auction status output data from the mass data store. The auction status output data is stored in a structured manner to be used in the generation of an interface such as using dynamic web pages. It is stored by synchronizing to the mass data store data periodically to provide fast access to the structured data for the confirmed auction status.

The stored data 100 also comprises uncommitted auction bid data 102. This data can always be stored as the bid data is received or it can be store only after receipt of event data. The data can be stored in unprocessed form or in a simple preprocessed form. This data can be used in the generation of the auction interface in conjunction with output formatted structured data 101 the so that the auction interface is more up to date than the processed auction data stored in the mass data store. Of course, there is a possibility that the processing of bid data for storage in the mass data store may determine that the bid data is not valid, e.g. the user's account does not have funds or the bet upon event is invalid. In this case, the bid data stored in the uncommitted data 102 and used for a rapidly updated auction interface will need to be updated to indicate or show that the hid associated with the invalid bid data was not accepted in the confirmed status of the auction as represented by the data stored in the mass data store.

The uncommitted bid data 102 stored in fast access volatile memory can thus serve the function of:
Allowing a fast auction interface to be generated showing both confirmed bid data and unconfirmed bid data
Storing bid data after an event is indicated in event data to cache the bid data for use in case the event is invalid or unconfirmed
Storing bid data for a period related to the delay in receiving event data to allow delayed processing of the bid data to ensure bid data cannot be processed for bids submitted by bidders after the occurrence of the event potentially closing the auction

The bid data stored in the temporary data store can be preprocessed into loosely structured data such as data per item or auction lots linked to a data for each of a series of bids.

The data stored in the mass data store comprises highly structured data such as a database that is capable of being queried to search for data. For example, the data could be structured as a relational database having, some of the following data fields and entries for example:

Bet data with the following example data/;
Bet ID
Event ID
Bookmaker ID
User ID
Auction lot ID

Auction lot data with the following example data:

Auction lot ID
Bet ID
Auction end rules e.g.
   i. start of game
   ii. end of game

Event data with the following example data:
Event ID
Event data

Bid data having the following example data:
Bid data ID
Auction lot ID
User ID
Bid data
   i. Time
   ii. Type e.g. buy it now, fixed or max number

User data having the following example data:
User ID
Username and password
Address
Financial data

Bookmaker data having the following example data:
Bookmaker ID
Name
Computer connection data
Financial data

This data is illustrative only of the related sets of data that can be stored in the mass data store.

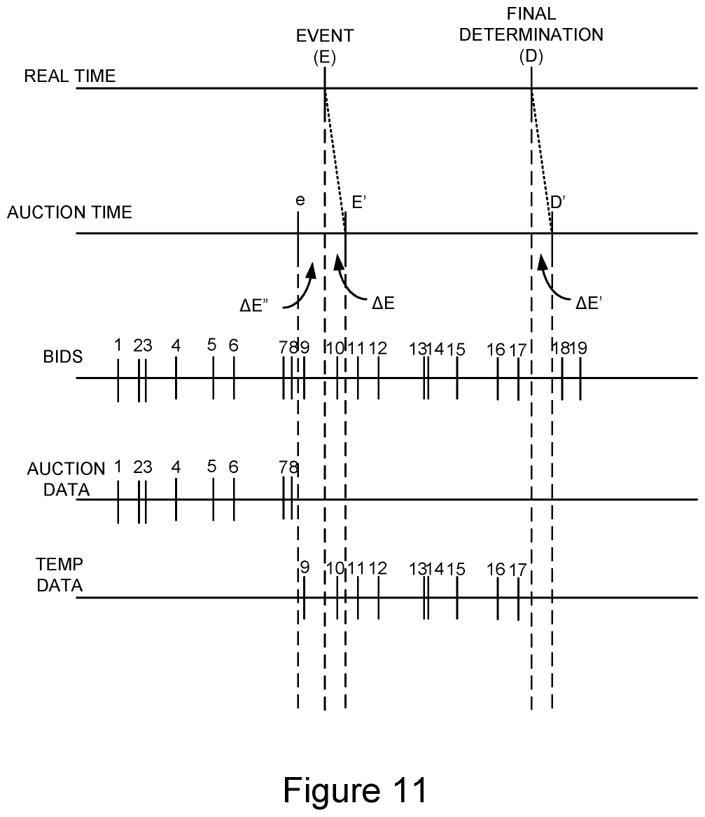

The timing of the bid data reception and processing will now be discussed with reference to the timing diagram of FIG. 11.

The top line in FIG. 11 illustrates real time and indicates an event, such as a goal or touchdown, occurring at time E with a time delay before there is a final determination on the validity of the event, such as whether the goal stands or is disallowed, at time D. The real-time event, such as a sports event is watched in real time by spectators (who can also be bidders) and is subject to data digitization to form event data which may accompany a video feed. The event data and video feed is transmitted over a network such as the internet to the auction computer. Such a transmission experiences a transmission delay over the network, which is dependent upon a lot of factors related to the network.

The second line is indicative of the auction computer time and shows that the event indicator in the event data is received at a time E′ which comprised E+ΔE. Similarly, the final determination is received at a time D′ which equals D+ΔE. Hence, if a bidder had access to a fast network connection, they could after they had viewed the event theoretically submit a bid to the auction computer that arrived before the event data at time E′. In order to avoid this, a period is determined that is sufficiently prior to the actual event time E to ensure that no such bids can be made and accepted. The period comprises the period ΔE plus an additional safety period ΔE′ in case there is any variance in ΔE. Therefore, the auction computer closes the auction at time e and does not accept bids received after this time unless the event is finally determined not to be valid, in which case the late bids are processed.

The third timeline is the timeline of receipt of the bids at the auction computer. Nineteen bids are shown as sequentially numbered bids at the time they are received. These bids arrive before the time e, between the time e and E′ and before and after time D′.

The fourth timeline shows the bid data processing timing. It can be seen in FIG. 11 that bids 1 to 8 are received before time e and are therefore fully processed into the mass data store as confirmed auction status data.

The fifth timeline shows the data stored in the temporary data store in one embodiment. The data received after time e in this embodiment is not stored in the mass data store and is instead stored as unprocessed or simply processed data in the temporary data store. The bid data is however only stored in the temporary data store up to time D′: receipt of the final determination data. Bid data received after D′ is not stored.

In this embodiment, the bid data is not stored in the temporary data store until the mass data store stops processing the bid data at time e, which is a predetermined period before the event data is received. What happens to the bid data stored in the temporary data store will depend on whether the final determination data indicates that the event is valid or not. If the final determination indicates that the event is valid, then the bid data in the temporary, data store represents bids that were received after the auction closed and therefore the bid data can be deleted from the temporary data store and may be stored in the mass data store for audit purposes. If the final determination indicates that the event is not valid, the bid data stored in the temporary data store between the time e and time D′ represents valid hid data and is deleted from the temporary data store and processed for storage in the mass data store as auction data. Any bid data received after time D′ in this case is then processed in the fourth timeline as bid data that is processed into the mass data store repeating the process shown in the fourth line.

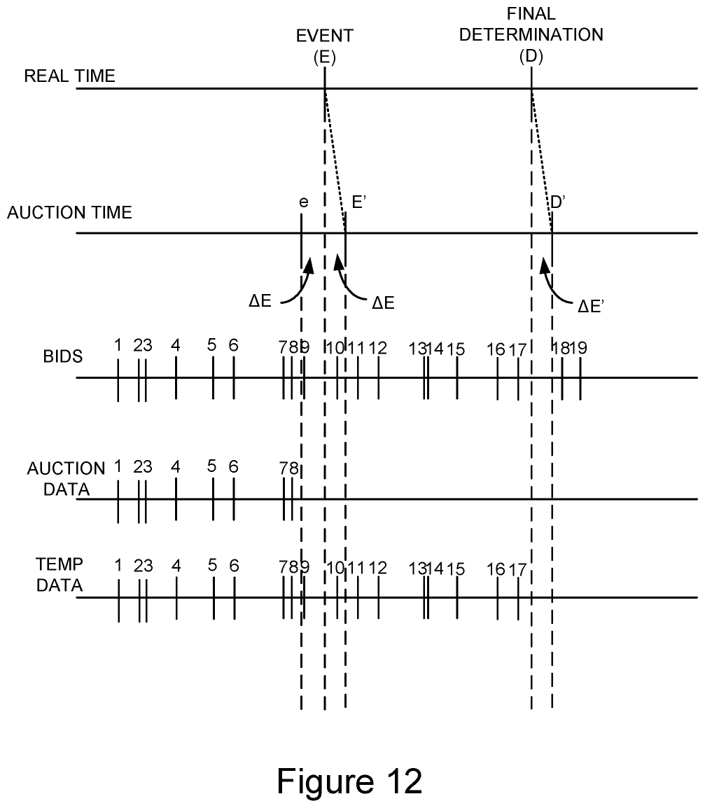

A second example of the timing of the bid data reception and processing will now be discussed with reference to the timing diagram of FIG. 12.

The top line illustrates real time indicating an event, such as a goal or touchdown, occurring at time E with a time delay before there is a final determination on the validity of the event, such as whether the goal stands or is disallowed, at time D. The real-time event, such as a sports event is watched in real time by spectators (who may be bidders) and is subject to data digitization to form event data which may accompany a video feed. The event data and video feed is transmitted over a network, such as the internet to the auction computer. Such a transmission experiences a transmission delay over the network, which is dependent upon a lot of factors related to the network.

The second line is indicative of the auction computer time and shows that the event indicator in the event data is received at a time E′ which comprised E+ΔE. Similarly, the final determination is received at a time D″ which equals D+ΔE. Hence, if a bidder had access to a fast network connection, they could, after they had viewed the event, theoretically submit a bid to the auction computer that arrived before the event data at time E′. In order to avoid this, a period is determined that is sufficiently prior to the actual event to ensure that no such bid can be made and accepted. The period comprises the period ΔE plus an additional safety period ΔE″ in case there is any variance in ΔE. Therefore, the auction computer closes the auction at time e and does not accept bids received after this time unless the event is finally determined not to be valid, in which case the late bids are processed.

The third timeline is the timeline of receipt of the bids at the auction computer. Nineteen bids are shown at the time they are received. These bids arrive before the time e, between the time e and E′ and before and after time D.

The fourth timeline shows the bid data processing timing. It can be seen in FIG. 12 that bids 1 to 8 are received before time e and are therefore fully processed into the mass data store as confirmed auction status data. The data received after time e in this embodiment is not stored in the mass data store.

The fifth timeline shows the data stored in the temporary data store in this embodiment. The bid data received is stored as unprocessed or simply processed data in the temporary data store as well as in the mass data store for the period before time e. The bid data is however only stored in the temporary data store up to time D′: receipt of the final determination data. Bid data received after time D′ is not stored.

What happens to the bid data stored in the temporary data store for the period between time e and time D′ will depend on whether the final determination data indicates that the event is valid or not. If the final determination indicates that the event is valid, then the bid data in the temporary data store represents bids that were received after the auction closed and therefore the bid data can be deleted from the temporary data store and may be stored in the mass data store for audit purposes. If the final determination indicates that the event is not valid, the bid data stored in the temporary data store between the time e and time D′ represents valid hid and is deleted from the temporary data store and processed for storage in the mass data store as auction data. Any bid data received after time D′ in this case is then processed in the fourth timeline as bid data that is processed into the mass data store in the manner of starting again from the left of the timeline.

In this embodiment, the bid data is stored in the temporary data store even before receiving the event data at time e. The bid data can thus be used in the formation of the auction interface along with the auction status output data stored in the temporary data store.

The auction apparatus and method can thus provide an improved auction process.

Examples of an auction process will now be described.

In one example of an auction process, Torn has a bet on Thundering Gavel in the 3.15 at Kempton. He lists the bet as a lot for auction, to close any time up to the outcome of the race. The highest bid at the start of the race is £9.

Dick and Harry are watching the race on television, while using their mobile phones and an app to access the auction computer over the internee. At time 3.1.8:30.000, Thundering Gavel is ahead by a nose. Dick bids £10. The auction computer updates the temporary data store with this bid data, taking 0.005 seconds to do so and it begins the process of processing and validating the bid data to add it to the auction data, taking 1.500 seconds to do so, because the bookmaker's or financial system must confirm that Dick has the required funds etc.

At 3.18:31.000 Harry's view of the auction on the auction interface has already been updated from the temporary data store. He sees Dick's bet and bids £10.50 to beat it.

At 3.18.31:050 the auction computer received event data from the sports feed that the race is in the final half furlong. The process of closing the auction and transferring bet ownership begins. The process must complete before the bet is closed of settled by the bookmaker.

Harry's bid is in the temporary data store at this point but not yet in the mass data store as confirmed auction data. Harry's hid is validated and he is determined the winner of the auction and so the bet is transferred to Harry.

Without the caching of the bid data in the temporary data store and the use of this in the generation of the auction interface, Harry would not have known about Dick's bid in time to place a bid.

Alternatively, Harry's bid cannot be validated and hence the transfer of ownership cannot be completed. This could be for several reasons, such as lack of funds. Therefore, the prior bid by Dick is taken as the highest bid and assuming it has been validated, the bet is transferred to Dick.

In a different example of an auction process, Tom places a bet on Goals Over/Under/Over, over 1.5 in football. The bet is processed into the mass data store. The current score in the game is 1-0 with a minute still to play.

Dick places a bid of £50, which meets Tom's reserve price.

The auction computer receives a data update that the home team have scored. No more bids are accepted into the auction data in the mass data store. The process of closing the auction in favour of Dick begins, which will take 3 seconds.

Meanwhile 300 people watching the game bid on the lot expecting to win. The highest bid climbs to £250. These bids are stored in the temporary data store only.

The live sports feed updates again with the final determination. The goal was disallowed by the referee after conferring with an assistant, so the current score is still 1-0.

The end of auction process is interrupted and cancelled. The auction continues with the current high bid of £250. All the bids received after the initial event are processed, validated and stored. The auction then concludes as normal just before full time.

In this way, the processing and storage of bids after a potential event are suspended awaiting confirmation or validation of the event to avoid ongoing auction processing that might have to be reversed. If the event is determined to be invalid, it is simple for the auction computer to perform catch up processing on the bid data stored in the temporary data store.

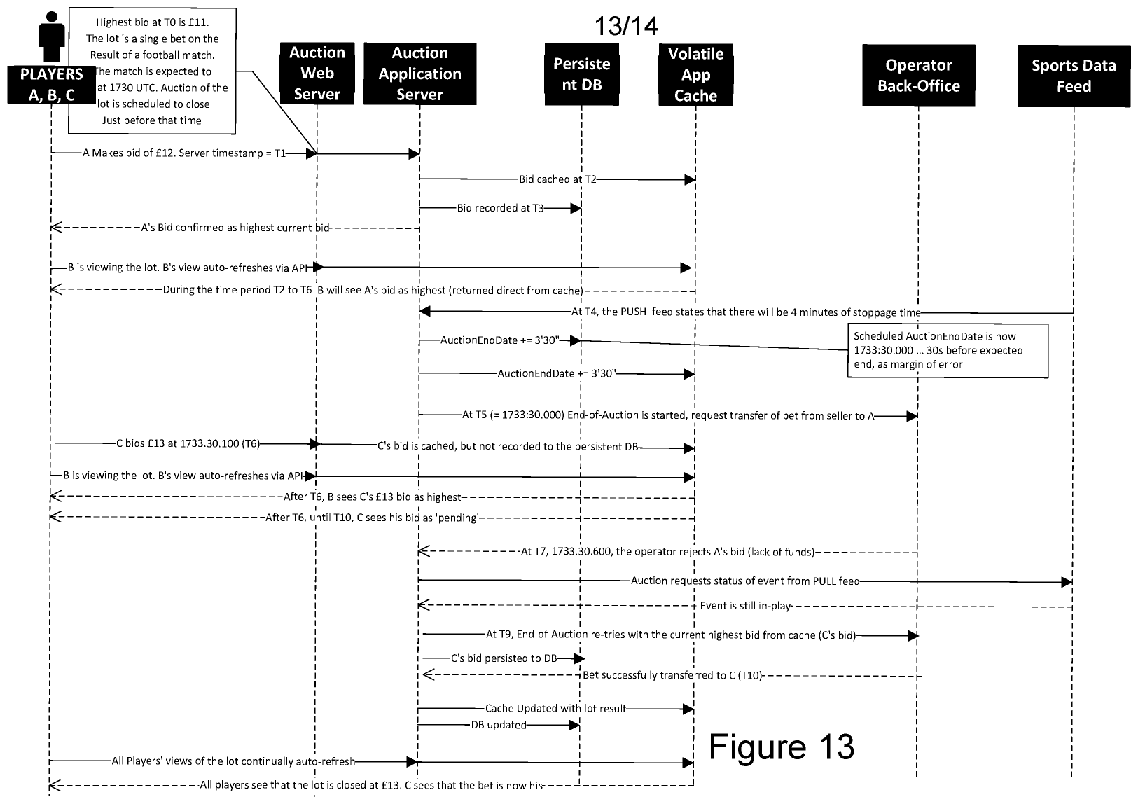

FIG. 13 is a diagram illustrating an auction bidding and data refresh process with the auction closing according to one embodiment.

There are three players (bidders) A, B and C. At T0 the highest bid is £11. The lot is a single bet on the result of a football match. The result is expected to finish at 17.30 UTC and the auction of the lot is scheduled to close just before that time.

Player A makes a bid of £12 and this is given the server timestamp of T1 when received by the web server. The hid is passed to the application server and cached in the temporary data store at time T2. The bid is also processed and recorded into the database at a later time T3 due to the processing time. The application server generates an output to the players on the interface confirming A's bid as the highest current bid. Player B is viewing on B's computer and B's interface is auto-refreshed by the web server using the cached data. During the time T2 to T6 B will see A's bid as the highest bid due to the use of the cached data in the formation of the interface.

At time T4 there is a data feed pushed from the data source to state that 4 minutes of stoppage time has been added to the end of the match. This data feed is received by the application server and the application server updates the end of the auction to add 3 minutes and 30 seconds. This is added to both the database and the cache so that the scheduled end time in the database is now 15.33:30.000, 30 seconds before the expected end of the match to allow for error. At time T5 (at 15.33:30.000) the end of auction process is started by the application server and the back office or bookmaker is contacted with the request that the bet be transferred from seller to player A.

In the meantime, player C bids £13 at time 15.33:30.100 (time T6) and this is received at the web server and the bid is sent to the cache but not processed to the database. After time T6 player B sees C's £13 bid as the highest bid even though it has not yet been confirmed since player B is viewing the interface generated using the cache data. Player C sees their bid as pending from the view of the cache data.

At time T7 at 15.33:30.600 the bid from player A is rejected by the back office (bookmaker and financial function) due to lack of funds and this is notified to the application server. The application server requests a status of the event from the data source in a PULL feed and data indicating that the event is still in play is returned. At time T9 the application server sends an end of auction notice to the back office (bookmaker) with the current highest bidder from the cache which is now C and C's bid is processed into the database. The back office accepts or validates the bid from C at time T10 and the application server updates the cache with the lot result and the database is updated. Since the cache is updated with the closed auction data, all the players now see that the lot is closed and that player C is the winner with their hid of £13.

It can be seen from the above that the use of the cache allows bets to be accepted and held pending validation of events and other bidders bids so that if the bid or the event is invalidated, the cached bids can be accepted and validated into the auction by processing into the auction database.

### Basic Computing Device

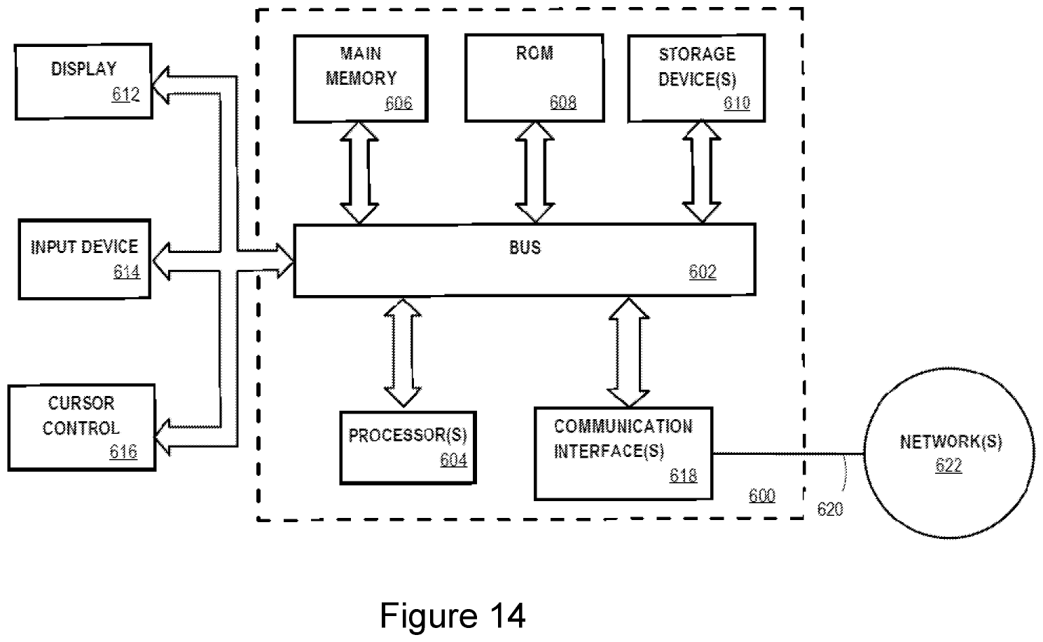

FIG. 14 is a block diagram that illustrates a basic computing device 600 in which the example embodiment(s) of the present invention may be embodied. Computing device 600 and its components, including their connections, relationships, and functions, is meant to be exemplary only, and not meant to limit implementations of the example embodiment(s). Other computing devices suitable for implementing the example embodiment(s) may have different components, including components with different connections, relationships, and functions.

The computing device 600 can comprise any of the servers or the user device as illustrated in FIG. 1 for example.

Computing device 600 may include a bus 602 or other communication mechanism for addressing main memory 606 and for transferring data between and among the various components of device 600.

Computing device 600 may also include one or more hardware processors 604 coupled with bus 602 for processing information. A hardware processor 604 may be a general-purpose microprocessor, a system on a chip (SoC), or other processor.

Main memory 606, such as a random-access memory (RAM) or other dynamic storage device, also may be coupled to bus 602 for storing information and software instructions to be executed by processor(s) 604. Main memory 606 also may be used for storing temporary variables or other intermediate information during execution of software instructions to be executed by processor(s) 604.

Software instructions, when stored in storage media accessible to processor(s) 604, render computing device 600 into a special-purpose computing device that is customized to perform the operations specified in the software instructions. The terms “software”, “software instructions”, “computer program”, “computer-executable instructions”, and “processor-executable instructions” are to be broadly construed to cover any machine-readable information, whether or not human-readable, for instructing a computing device to perform specific operations, and including, but not limited to, application software, desktop applications, scripts, binaries, operating systems, device drivers, boot loaders, shells, utilities, system software, JAVASCRIPT, web pages, web applications, plugins, embedded software, microcode, compilers, debuggers, interpreters, virtual machines, linkers, and text editors.

Computing device 600 also may include read only memory (ROM) 608 or other static storage device coupled to bus 602 for storing static information and software instructions for processor(s) 601.

One or more mass storage devices 610 may be coupled to bus 602 for persistently storing information and software instructions on fixed or removable media, such as magnetic, optical, solid-state, magnetic-optical, flash memory, or any other available mass storage technology. The mass storage may be shared on a network, or it may be dedicated mass storage. Typically, at least one of the mass storage devices 610 (e.g., the main hard disk for the device) stores a body of program and data for directing operation of the computing device, including an operating system, user application programs, driver and other support files, as well as other data files of all sorts.

Computing device 600 may be coupled via bus 602 to display 612, such as a liquid crystal display (LCD) or other electronic visual display, for displaying information to a computer user. In some configurations, a touch sensitive surface incorporating touch detection technology (e.g., resistive, capacitive, etc.) may be overlaid on display 612 to form a touch sensitive display for communicating touch gesture (e.g., finger or stylus) input to processor(s) 604.

An input device 614, including alphanumeric and other keys, may be coupled to bus 602 for communicating information and command selections to processor 604. In addition to or instead of alphanumeric and other keys, input device 614 may include one or more physical buttons or switches such as, for example, a power (on/off) button, a “home” button, volume control buttons, or the like.

Another type of user input device may be a cursor control 616, such as a mouse, a trackball, a cursor, a touch screen, or direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane. Other input device embodiments include an audio or speech recognition input module to recognize audio input such as speech, a visual input device capable of recognizing gestures by a user, and a keyboard.

While in some configurations, such as the configuration depicted in FIG. 14, one or more of display 612, input device 614, and cursor control 616 are external components (i.e., peripheral devices) of computing device 600, some or all of display 612, input device 614, and cursor control 616 are integrated as part of the form factor of computing device 600 in other configurations.

In addition to or in place of the display 612 any other form of user output device can be such as an audio output device or a tactile (vibrational) output device.

Functions of the disclosed systems, methods, and modules may be performed by computing device 600 in response to processor(s) 604 executing one or more programs of software instructions contained in main memory 606. Such software instructions may be read into main memory 606 from another storage medium, such as storage device(s) 610 or a transmission medium. Execution of the software instructions contained in main memory 606 cause processor(s) 604 to perform the functions of the example embodiment(s).

While functions and operations of the example embodiment(s) may be implemented entirely with software instructions, hard-wired or programmable circuitry of computing device 600 (e.g., an ASIC, a FPGA, or the like) may be used in other embodiments in place of or in combination with software instructions to perform the functions, according to the requirements of the particular implementation at hand.

The term “storage media” as used herein refers to any non-transitory media that store data and/or software instructions that cause a computing device to operate in a specific fashion. Such storage media may comprise non-volatile media and/or volatile media. Non-volatile media includes, for example, non-volatile random-access memory (NVRAM), flash memory, optical disks, magnetic disks, or solid-state drives, such as storage device 610. Volatile media includes dynamic memory, such as main memory 606. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, flash memory, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio-wave and infra-red data communications. A machine-readable medium carrying instructions in the form of code can comprise a non-transient storage medium and a transmission medium.

Various forms of media may be involved in carrying one or more sequences of one or more software instructions to processor(s) 604 for execution. For example, the software instructions may initially be carried on a magnetic disk or solid-state drive of a remote computer. The remote computer can load the software instructions into its dynamic memory and send the software instructions over a telephone line using a modem. A modem local to computing device 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor(s) 604 retrieves and executes the software instructions. The software instructions received by main memory 606 may optionally be stored on storage device(s) 610 either before or after execution by processor(s) 604.

Computing device 600 also may include one or more communication interface(s) 618 coupled to bus 602. A communication interface 618 provides a two-way data communication coupling to a wired or wireless network link 620 that is connected to a local network 622 (e.g., Ethernet network, Wireless Local Area. Network, cellular phone network, Bluetooth wireless network, or the like). Communication interface 618 sends and receives electrical, electromagnetic, or optical signals that carry digital data streams representing various types of information. For example, communication interface 618 may be a wired network interface card, a wireless network interface card with an integrated radio antenna, or a modem (e.g., ISDN, DSL, or cable modem).

Network link(s) 620 typically provide data communication through one or more networks to other data devices. For example, a network link 620 may provide a connection through a local network 622 to a host computer or to data equipment operated by an Internet Service Provider (ISP). ISP in turn provides data communication services through the world wide packet data communication network now commonly referred to as the “Internet”. Local network(s) 622 and Internet use electrical, electromagnetic or optical signals that carry digital data streams. The signals through the various networks and the signals on network link(s) 620 and through communication interface(s) 618, which carry the digital data to and from computing device 600, are example forms of transmission media.

Computing device 600 can send messages and receive data, including program code, through the network(s), network link(s) 620 and communication interface(s) 618. In the Internet example, a server might transmit a requested code for an application program through Internet, ISP, local network(s) 622 and communication interface(s) 618.

The received code may be executed by processor 604 as it is received, and/or stored in storage device 610, or other non-volatile storage for later execution.

One aspect provides a carrier medium or machine-readable medium, such as a non-transient storage medium storing code for execution by a processor of a machine to carry, out the method, or a transient medium carrying processor executable code for execution by a processor of a machine to carry out the method. Embodiments can be implemented in programmable digital logic that implements computer code. The code can be supplied to the programmable logic, such as a processor or microprocessor, on a carrier medium. One such embodiment of a carrier medium or machine-readable medium is a transient medium i.e. a signal such as an electrical, electromagnetic, acoustic, magnetic, or optical signal. Another form of carrier medium or machine-readable medium is a non-transitory storage medium that stores the code, such as a solid-state memory, magnetic media (hard disk drive), or optical media (Compact disc (CD) or digital versatile disc (DVD)).

It will be readily understood to those skilled in the art that various other changes in the details, material, and arrangements of the parts and method stages which have been described and illustrated in order to explain the nature of the inventive subject matter may be made without departing from the principles and scope of the inventive subject matter as expressed in the subjoined claims.

1. Apparatus for processing auction data, the system comprising:
a mass data store storing structured auction data defining the status of an auction;
a temporary data store;
a processor; and
program memory storing processor implementable instructions, which when implemented by the processor, causes the processor to:
receive bid data representing bids for an auction lot the subject of the auction;
process and store the bid data in the mass data store to record the current confirmed status of the auction;
receive event data representing an event during the auction that potentially closes the auction;
after receiving the event data, cease processing and storing the bid data in the mass data store and store the bid data for any bids received after the event data in the temporary data store;
receive event determination data indicating whether the event is confirmed or not;
if the event determination data indicates that the event is not confirmed, process the bid data stored in the temporary data store, store the processed bid data in the mass data store to record and update the current confirmed status of the auction, and resume receiving, processing and storing the bids in the mass data store to record the current confirmed status of the auction; and
if the event determination data indicates that the event is confirmed, update the status of the auction to closed.

2. Apparatus according to claim 1, wherein the processor implementable instructions comprise instructions, which when implemented by the processor, causes the processor to, if the event determination data indicates that the event is confirmed, transfer the received bid data stored in the temporary data store for storage in the mass data store without updating the confirmed status of the auction.

3. Apparatus according to claim 1, wherein the processor implementable instructions comprise instructions, which when implemented by the processor, causes the processor to, if the event determination data indicates that the event is confirmed, delete the received bid data stored in the temporary data store.

4. Apparatus according to claim 1, wherein the processor implementable instructions comprise instructions, which when implemented by the processor, causes the processor to, when the bid data is received, store the received bid data in the temporary data store.

5. Apparatus according to claim 1, wherein the processor implementable instructions comprise instructions, which when implemented by the processor, causes the processor to process the received bid data by delaying processing and storing received bid data in the mass data store for a period of time.

6. Apparatus according to claim 1, wherein the temporary data store has a faster data access speed than the mass data store.

7. Apparatus according to claim 5, wherein the temporary data store has a faster data access speed than the mass data store, and the processor implementable instructions comprise instructions, which when implemented by the processor, causes the processor to:
generate auction status output data from the auction data stored in the mass data store;
store the auction status output data in the temporary data store; and
generate auction user interface data using the auction status output data and the bid data stored in the temporary data store that has not yet been processed and stored in the mass data store.

8. Apparatus according to claim 1, wherein the auction lot comprises a bet on the event, the auction data includes bet data, and the processor implementable instructions comprise instructions, which when implemented by the processor, causes the processor to receive the event data and the event determination data from a source of data associated with the bet upon event.

9. Apparatus for processing auction data, the system comprising:
a mass data store storing structured auction data defining the status of an auction;
a temporary data store, the temporary data store having a faster data access speed than the mass data store;
a processor; and
program memory storing processor implementable instructions, which when implemented by the processor, causes the processor to:
receive bid data representing bids for an auction lot the subject of the auction;
store the bid data in the temporary data store;
process the bid data and store the processed bid data in the mass data store to record the current confirmed status of the auction;
generate auction status output data from the auction data stored in the mass storage device;
store the auction status output data in the temporary data store; and
generate auction user interface data using the auction status output data and the bid data stored in the temporary data store that has not yet been processed and stored in the mass data store.

10. Apparatus according to claim 9, wherein the auction lot comprises a bet on an event, the auction data includes bet data, and the processor implementable instructions comprise instructions, which when implemented by the processor, causes the processor to:
receive event data from a source of data associated with the bet upon event; and
cease processing and storing the bid data in the mass data store for bid data received after the receipt of the event data.

11. Apparatus according to claim 10, wherein the processor implementable instructions comprise instructions, which when implemented by the processor, causes the processor to:
process and store the processed bid data for each bid in the mass data store to determine whether the processed bid data is valid; and
if the processed bid data for a bid is not valid, the processed bid data is stored in the mass data store so that the current confirmed status of the auction does not include the bid.

12. A computer implemented method of processing auction data using a mass data store storing structured auction data defining the status of an auction and a temporary data store, the method comprising:
receiving bid data representing bids for an auction lot the subject of the auction;
processing and store the bid data in the mass data store to record the current confirmed status of the auction;
receiving event data representing an event during the auction that potentially closes the auction;
after receiving the event data, cease processing and storing the bid data in the mass data store and store the bid data for any bids received after the event data in the temporary data store;
receiving event determination data indicating whether the event is confirmed or not;
if the event determination data indicates that the event is not confirmed, processing the bid data stored in the temporary data store, storing the processed bid data in the mass data store to record and update the current confirmed status of the auction, and resuming receiving, processing and storing the bids in the mass data store to record the current confirmed status of the auction; and
if the event determination data indicates that the event is confirmed, updating the status of the auction to closed.

13. A computer implemented method according to claim 12, wherein if the event determination data indicates that the event is confirmed, the received bid data stored in the temporary data store is transferred for storage in the mass data store without updating the confirmed status of the auction.

14. A computer implemented method according to claim 12, wherein if the event determination data indicates that the event is confirmed, the received bid data stored in the temporary data store is deleted.

15. A computer implemented method according to claim 12, wherein when the bid data is received, the received bid data is stored in the temporary data store.

16. A computer implemented method according to claim 15, wherein the processing and storing of the received bid data comprises delaying processing and storing received bid data in the mass data store for a period of time.

17. A computer implemented method according to claim 12, wherein the temporary data store has a faster data access speed than the mass data store.

18. A computer implemented method according to claim 15, wherein the temporary data store has a faster data access speed than the mass data store, and the method includes:
generating auction status output data from the auction data stored in the mass data store;
storing the auction status output data in the temporary data store; and
generating auction user interface data using the auction status output data and the bid data stored in the temporary data store that has not yet been processed and stored in the mass data store.

19. A computer implemented method according to claim 12, wherein the auction lot comprises a bet on the event, the auction data includes bet data, and the event data and the event determination data is received from a source of data associated with the bet upon event.

20. A computer implemented method of processing auction data using a mass data store storing structured auction data defining the status of an auction and a temporary data store, the temporary data store having a faster data access speed than the mass data store, the method comprising:
receiving bid data representing bids for an auction lot the subject of the auction;
storing the bid data in the temporary data store;
processing the bid data and storing the bid data in the mass data store to record the current confirmed status of the auction;
generating auction status output data from the auction data stored in the mass storage device;
storing the auction status output data in the temporary data store; and
generating auction user interface data using the auction status output data and the bid data stored in the temporary data store that has not yet been processed and stored in the mass data store.

21. A computer implemented method according to claim 20, wherein the auction lot comprises a bet on an event, the auction data includes bet data, and the method includes:
receiving event data from a source of data associated with the bet upon event; and
ceasing processing and storing the bid data in the mass data store for bid data received after the receipt of the event data.

22. A computer implemented method according to claim 21, wherein the processing and storing of the bid data in the mass data store includes determining whether the processed bid data is valid, and if the processed bid data for a bid is not valid, the processed bid data is stored in the mass data store so that the current confirmed status of the auction does not include the bid.

23. A non-transient storage medium storing machine-readable instructions, which when executed by a processor of a machine, causes the machine to:
process auction data using a mass data store storing structured auction data defining the status of an auction and a temporary data store by:
receiving bid data representing bids for an auction lot the subject of the auction;
processing and store the bid data in the mass data store to record the current confirmed status of the auction;
receiving event data representing an event during the auction that potentially closes the auction;
after receiving the event data, cease processing and storing the bid data in the mass data store and store the bid data for any bids received after the event data in the temporary data store;
receiving event determination data indicating whether the event is confirmed or not;
if the event determination data indicates that the event is not confirmed, processing the bid data stored in the temporary data store, storing the processed bid data in the mass data store to record and update the current confirmed status of the auction, and resuming receiving, processing and storing the bids in the mass data store to record the current confirmed status of the auction; and
if the event determination data indicates that the event is confirmed, updating the status of the auction to closed.

24. (canceled)

25. A non-transient storage medium storing machine-readable instructions, which when executed by a processor of a machine, causes the machine to:
process auction data using a mass data store storing structured auction data defining the status of an auction and a temporary data store, the temporary data store having a faster data access speed than the mass data store, by:
receiving bid data representing bids for an auction lot the subject of the auction;
storing the bid data in the temporary data store;
processing the bid data and storing the bid data in the mass data store to record the current confirmed status of the auction;
generating auction status output data from the auction data stored in the mass storage device;
storing the auction status output data in the temporary data store; and
generating auction user interface data using the auction status output data and the bid data stored in the temporary data store that has not yet been processed and stored in the mass data store.
